(19) United States
(12) Patent Application Publication
(10) Pub. No.: US 2025/0079694 A1
(43) Pub. Date: Mar. 6, 2025

(54) TRANSPORT ROBOT

(71) Applicant: TOYOTA JIDOSHA KABUSHIKI KAISHA, Toyota-shi (JP)

(72) Inventors: Daiki FUKUNAGA, Toyota-shi (JP); Shiro ODA, Anjo-shi (JP); Takeshi MATSUI, Nissin-shi (JP)

(73) Assignee: TOYOTA JIDOSHA KABUSHIKI KAISHA, Toyota-shi (JP)

(21) Appl. No.: 18/594,138

(22) Filed: Mar. 4, 2024

(30) Foreign Application Priority Data
Apr. 28, 2023 (JP) 2023-074678

(51) Int. Cl. H01Q 1/32; G05D 1/656; G05D 105/20; G05D 111/30

(52) U.S. Cl. CPC H01Q 1/325; G05D 1/656; H01Q 1/3216; G05D 2105/20; G05D 2111/30

(57) ABSTRACT

A transfer robot includes: a platform configured to allow a transport object to be mounted on the platform; a stand that extends upward from the platform; and a wireless communication unit configured to perform wireless communication with an external device using radio waves in a predetermined frequency band. The wireless communication unit includes a first wireless communication antenna and a second wireless communication antenna disposed so as to receive radio waves at least from an outer side in a direction parallel to the platform. The first wireless communication antenna and the second wireless communication antenna are disposed on opposite end surface sides of the platform with a center portion of the platform interposed between each other in the direction parallel to the platform.

### CROSS-REFERENCE TO RELATED APPLICATION

This application claims priority to Japanese Patent Application No. 2023-074678 filed on Apr. 28, 2023, incorporated herein by reference in its entirety.

### BACKGROUND

### 1. Technical Field

The present disclosure relates to a transport robot.

### 2. Description of Related Art

Japanese Unexamined Patent Application Publication No. 2006-166010 (JP 2006-166010 A) discloses an in-vehicle communication antenna structure intended to improve the antenna performance and the mountability of a communication antenna. In the in-vehicle communication antenna structure described in JP 2006-166010 A, a vehicle is provided with an antenna portion in order to enable communication between an in-vehicle device installed in the vehicle and a device carried in by an occupant, and the antenna portion is provided on the back side of an in-vehicle monitor provided in an instrument panel.

### SUMMARY

The present inventor has considered providing a transport robot with a stand that extends upward from a platform on which a transport object is to be mounted. The thus configured transport robot involves a fear that the reception state of radio waves may be degraded by the presence of the stand. Such an issue cannot be addressed using the technique described in JP 2006-166010 A, since it is difficult to receive radio waves from all directions with the technique.

The present disclosure provides a transport robot capable of suppressing degradation in the reception state of radio waves from all directions around a platform on which a transport object is to be mounted, even if a stand that extends upward from the platform is provided.

An aspect of the present disclosure provides a transfer robot including: a platform configured to allow a transport object to be mounted on the platform; a stand that extends upward from the platform; and a wireless communication unit configured to perform wireless communication with an external device using radio waves in a predetermined frequency band. The wireless communication unit includes a first wireless communication antenna and a second wireless communication antenna disposed so as to receive radio waves at least from an outer side in a direction parallel to the platform. The first wireless communication antenna and the second wireless communication antenna are disposed on opposite end surface sides of the platform with a center portion of the platform interposed between each other in the direction parallel to the platform. The transport robot configured as described above is provided with a stand that extends upward from the platform that allows a transport object to be mounted on the platform. However, the first wireless communication antenna and the second wireless communication antenna are disposed on opposite end surface sides of the platform with a center portion of the platform interposed between each other in the direction parallel to the platform. Hence, according to the transport robot configured as described above, it is possible to suppress degradation in the reception state of radio waves from all directions around the transport robot, that is, radio waves from all directions around the platform.

The first wireless communication antenna may be disposed inside the stand along a direction in which the stand extends. When the transport robot employs such a configuration, the first wireless communication antenna can not only be easily housed in the stand, but also keep a good reception state even when the external device is located at a position far from the transport robot.

The stand may include a non-conductive cover that covers a portion in which the first wireless communication antenna is disposed and forms a part of an outer casing of the stand. Providing such a cover can make the antenna visually unrecognizable from the outside, improving the appearance of the transport robot.

The stand may be disposed at a front portion or a rear portion of the platform and on one end side of the platform in a right-left direction. The transport robot makes it easy to visually recognize the mounting state of the transport object on the platform from the front side compared to a configuration in which the stand is disposed at the center portion of the platform in the right-left direction.

The stand may be disposed at a front portion or a rear portion of the platform and at a center portion of the platform in a right-left direction. The transport robot is well balanced in terms of weight of the transport robot compared to a configuration in which the stand is disposed on one end side of the platform in the right-left direction.

The stand may be disposed at a lateral portion of the platform and on one end side of the platform in a front-rear direction. The transport robot makes it easy to visually recognize the mounting state of the transport object on the platform from the front side or the rear side compared to a configuration in which the stand is disposed at the front portion or the rear portion of the platform. In addition, the transport robot makes it easy to visually recognize the transport state of the transport object on the platform from a lateral side compared to a configuration in which the stand is disposed at the center portion of the platform in the front-rear direction.

The stand may be disposed at a lateral portion of the platform and at a center portion of the platform in a front-rear direction. The transport robot makes it easy to visually recognize the mounting state of the transport object on the platform from the front side or the rear side compared to a configuration in which the stand is disposed at the front portion or the rear portion of the platform. In addition, the transport robot is well balanced in terms of weight of the transport robot compared to a configuration in which the stand is disposed on one end side of the platform in the front-rear direction.

The second wireless communication antenna may be disposed at a position inside the platform. When the transport robot employs such a configuration, it is not necessary to provide another stand in order to provide the second wireless communication antenna.

The second wireless communication antenna may be disposed at a position inside the platform and facing a position at which the first wireless communication antenna is disposed on a diagonal line in the direction parallel to the platform. When the transport robot employs such a configuration, degradation in the reception state can be suppressed better for radio waves from all directions around the transport robot, that is, radio waves from all directions around the platform.

The second wireless communication antenna may be disposed at a position inside the platform. The platform may include a non-conductive cover that covers a portion at which the second wireless communication antenna is disposed and forms a part of an outer casing of the platform. Providing such a cover can make the antenna visually unrecognizable from the outside, improving the appearance of the transport robot.

The transport robot may further include a different stand disposed on an opposite end surface side from the stand with a center portion of the platform interposed between the two stands in the direction parallel to the platform. The second wireless communication antenna may be disposed inside the different stand along a direction in which the different stand extends. When the transport robot employs such a configuration, the second wireless communication antenna can not only be easily housed in the different stand, but also keep a good reception state even when the external device is located at a position far from the transport robot.

The different stand may include a non-conductive cover that covers a portion at which the second wireless communication antenna is disposed and forms a part of an outer casing of the different stand. Providing such a cover can make the antenna visually unrecognizable from the outside, improving the appearance of the transport robot.

The first wireless communication antenna and the stand may be disposed at positions on the same surface side and away from each other in the direction parallel to the platform. When the transport robot employs such a configuration, it is not necessary to provide the stand with the first wireless communication antenna, achieving a reduction in weight and thickness of the stand.

The transport robot may further include an elevation mechanism provided on an upper surface side of at least a part of the platform and configured to load and unload a predetermined wagon as the transported object. The predetermined wagon may include a housing portion configured to house an article, and a support portion configured to support the housing portion with a space secured under the housing portion to allow insertion of at least a part of the platform. The first wireless communication antenna and the second wireless communication antenna may be disposed at positions not overlapping the predetermined wagon in the direction parallel to the platform with the predetermined wagon loaded on the platform. By employing such a configuration, the transport robot can not only transport articles in the wagon, but also suppress degradation in the reception state of radio waves even during transport of the wagon.

According to the present disclosure, it is possible to provide a transport robot capable of suppressing degradation in the reception state of radio waves from all directions around a platform on which a transport object is to be mounted, even if a stand that extends upward from the platform is provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view illustrating an example of the overall configuration of a transport robot according to an embodiment;

FIG. 2 is a top view of the transport robot in FIG. 1;

FIG. 3 is a perspective view illustrating how the transport robot in FIG. 1 transports a wagon;

FIG. 4 is a front view illustrating how the transport robot in FIG. 1 transports the wagon;

FIG. 5 is a side view illustrating how the transport robot in FIG. 1 transports the wagon;

FIG. 6 is a horizontal cross-sectional view illustrating an example of a stand of the transport robot in FIG. 1;

FIG. 7 is a horizontal cross-sectional view illustrating another example of the stand of the transport robot in FIG. 1;

FIG. 8 is a top view illustrating another example of the configuration of the transport robot according to the embodiment;

FIG. 9 is a top view illustrating another example of the configuration of the transport robot according to the embodiment;

FIG. 10 is a horizontal cross-sectional view illustrating an example of a stand of the transport robot in FIG. 9;

FIG. 11 is a top view illustrating another example of the configuration of the transport robot according to the embodiment;

FIG. 12 is a top view illustrating another example of the configuration of the transport robot according to the embodiment;

FIG. 13 is a top view illustrating another example of the configuration of the transport robot according to the embodiment;

FIG. 14 is a top view illustrating another example of the configuration of the transport robot according to the embodiment;

FIG. 15 is a top view illustrating another example of the configuration of the transport robot according to the embodiment; and

FIG. 16 is a top view illustrating another example of the configuration of the transport robot according to the embodiment.

### DETAILED DESCRIPTION OF EMBODIMENTS

While the present disclosure will be described below by way of an embodiment, the claims are not limited to the following embodiment. All the components described in relation to the embodiment are not necessarily essential as means for addressing the issue.

### EMBODIMENT

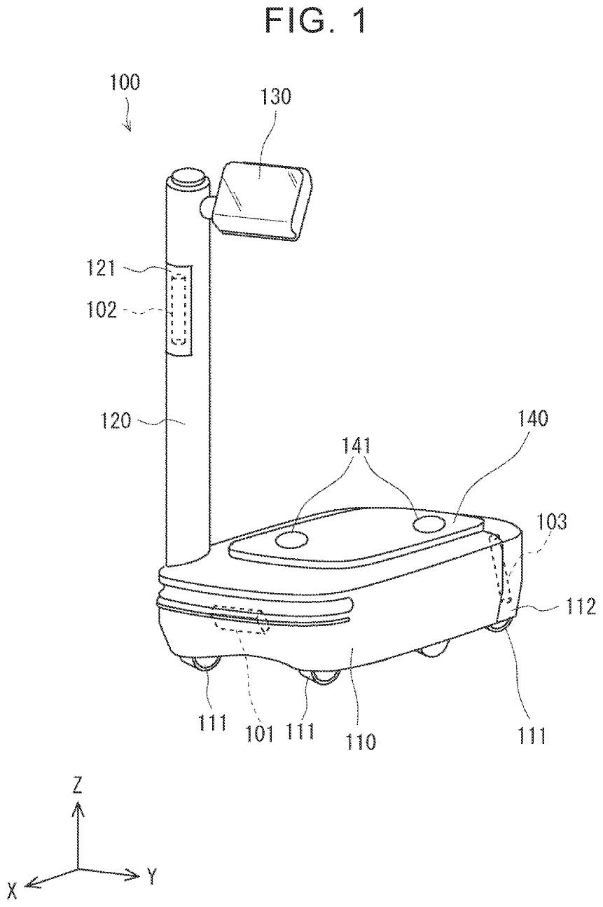

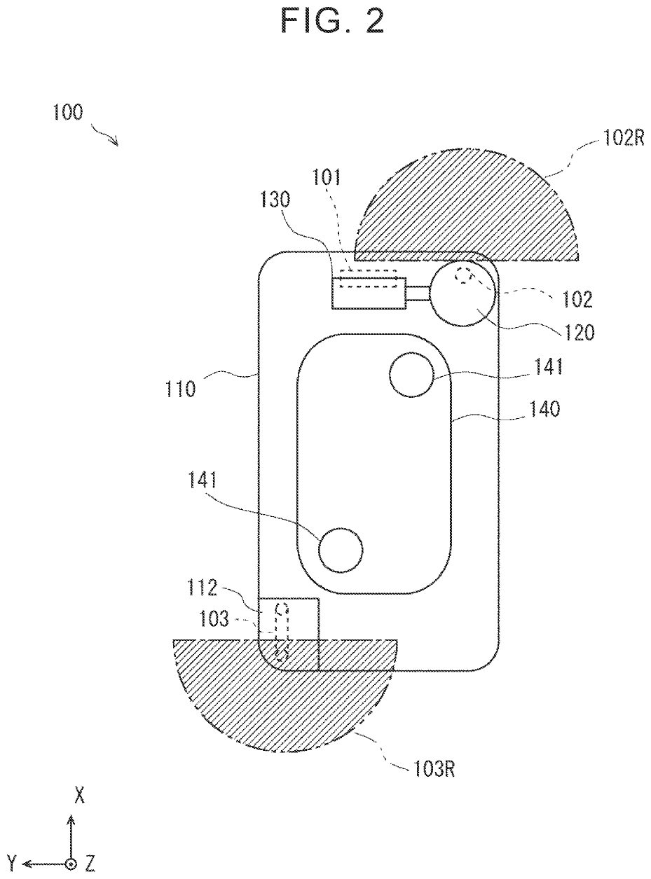

FIG. 1 is a perspective view illustrating an example of the overall configuration of a transport robot according to the present embodiment. FIG. 2 is a top view of the transport robot in FIG. 1. In the following description, an XYZ orthogonal coordinate system will be used as appropriate. An X direction is a front-rear direction of a transport robot 100 illustrated in FIG. 1, a Y direction is a right-left direction, and a Z direction is a vertical up-down direction. More specifically, a +X direction is defined as a forward direction of the transport robot 100, and a −X direction is defined as a rearward direction of the transport robot 100. A +Y direction is a leftward direction of the transport robot 100, and a −Y direction is a rightward direction of the transport robot 100. A +Z direction is a vertically upward direction, and a −Z direction is a vertically downward direction.

The transport robot 100 is movable in both the forward and rearward directions. That is, the transport robot 100 moves in the forward direction when its wheels are rotated forward, and moves in the rearward direction when the wheels are rotated in reverse. Changing the rotational speed between the right and left wheels allows the transport robot 100 to turn right or left.

As illustrated in FIGS. 1 and 2, the transport robot 100 may include a platform 110 on which a transport object is to be mounted, a stand 120, and an operation unit 130. The platform 110 is equipped with wheels 111, axles, a battery, a control computer 101, a drive motor, etc. It is assumed that the control computer 101 is mounted at the illustrated position in the platform 110. However, this is not limiting, and the control computer 101 may be mounted at any other position in the platform 110, or a part or all of the control computer 101 may be mounted in at least one of the stand 120 and the operation unit 130.

The platform 110 rotatably holds the wheels 111. Further, the platform 110 and the stand 120 may be provided with various sensors such as a camera and a distance measurement sensor, in order to suppress contact with an obstacle, check a route, etc., for example. In a configuration in which the transport robot 100 is an autonomous mobile robot and includes the platform 110 as illustrated in the drawings, the transport robot 100 may also be referred to as an autonomous mobile cart.

While a description is made here on the assumption that the transport robot 100 is an autonomous mobile robot, the transport robot 100 may be a mobile robot that moves according to operations by a user, or may be a mobile robot that is switchable between an autonomous travel mode and a user operation mode. The user may be a worker etc. at a facility in which the transport robot 100 is in service, and may be a hospital worker when the facility is a hospital. The transport robot 100 may be configured to transport a transport object according to instructions from a higher-level management device (not illustrated) with its movement route etc. managed by the higher-level management device. In this case, an external device to be discussed later may be the higher-level device or a wireless communication device connected to the higher-level device.

The control computer 101 can be implemented by an integrated circuit, for example, and can be implemented by a processor such as a micro processor unit (MPU) or a central processing unit (CPU), a working memory, a non-volatile storage device, etc., for example. The function to control the transport robot 100 can be achieved by the storage device storing a control program to be executed by the processor and the processor loading the program into the working memory and executing the program. The control computer 101 can be referred to as a control unit.

The transport robot 100 also includes a wireless communication unit that performs wireless communication with an external device using radio waves in a predetermined frequency band. The predetermined frequency band may include a plurality of frequency bands separated from each other. The wireless communication unit may be configured to perform wireless communication with an external device based on one or more wireless communication standards, among various wireless communication standards, such as Wi-Fi (registered trademark; the same applies hereinafter). The external device may be a wireless local area network (LAN) access point, a repeater, etc., for example. However, this is not limiting, and the external device may be any wireless communication device or any device with a wireless communication function.

The wireless communication unit includes a first wireless communication antenna (hereinafter simply referred to as a first antenna) 102 and a second wireless communication antenna (hereinafter simply referred to as a second antenna) 103 disposed so as to receive radio waves from at least the outer side in the direction parallel to the platform 110 (horizontal direction). The first antenna 102 and the second antenna 103 each have a length and a shape corresponding to radio waves in the predetermined frequency band.

The wireless communication unit may be connected to the control computer 101, or configured with portions of the wireless communication unit other than the first antenna 102 and the second antenna 103 included in the control computer 101. That is, in this configuration, the first antenna 102 and the second antenna 103 are both connected to the control computer 101. In the following description, portions of the wireless communication unit other than the first antenna 102 and the second antenna 103 are included in the control computer 101, in order to simply the description.

The second antenna 103 is disposed at a position inside the platform 110, and disposed at a position facing the position at which the first antenna 102 is disposed in the direction parallel to the platform 110, that is, on a diagonal line in top view. In the example in FIG. 1, the first antenna 102 is disposed in the stand 120, and the second antenna 103 is disposed at a diagonal position from the position at which the first antenna 102 is disposed. As discussed later, the stand 120 is a rod-shaped member that extends upward from the platform 110, and is attached to the platform 110.

In FIG. 1, the first antenna 102 and the second antenna 103 are disposed such that the first antenna 102 can receive radio waves from the front side (+X side) of the transport robot 100 and the second antenna 103 can receive radio waves from the rear side (−X side) of the transport robot 100. FIG. 2 illustrates the arrangement of the first antenna 102 and the second antenna 103 as seen from above the transport robot 100, and illustrates regions 102R and 103R as ranges in which the antennas receive radio waves for wireless communication with high sensitivity.

As exemplified in FIG. 1, the first antenna 102 can be disposed inside the stand 120 along a direction in which the stand 120 extends. When the transport robot 100 employs such a configuration, the first antenna 102 can not only be easily housed in the stand 120, but also keep a good reception state even when the external device is located at a position far from the transport robot 100.

As exemplified in FIGS. 1 and 2, the second antenna 103 may be disposed inside the platform 110 at an angle between the direction parallel to the platform 110 and the vertical direction, not at the direction parallel to the platform 110 or the vertical direction. By employing such a configuration, the transport robot 100 can keep a good reception state even if the external device is installed above the transport robot 100. The elevation angle of a direction from one end to the other end of the second antenna 103 relative to the direction parallel to the platform 110 may be more than 0 degrees and less than 90 degrees. When the elevation angle is around 45 degrees, for example, a good reception state can be kept for communication with an external device located directly above the transport robot 100 or an external device located at a position quite far from the transport robot 100.

As illustrated in FIG. 1, the stand 120 may include a non-conductive cover 121 that covers a portion in which the first antenna 102 is disposed and that forms a part of the outer housing of the stand 120. The first antenna 102 is disposed at a position on the outer side in the direction of the outer periphery and at which the first antenna 102 is not covered by a structural member of the stand 120 other than the cover 121. While the cover 121 may be made of a resin etc., for example, the cover 121 may be made of any non-conductive material, facilitating passage of radio waves to and from the first antenna 102. Providing the cover 121 can make the first antenna 102 visually unrecognizable from the outside, improving the appearance of the transport robot 100.

The outer casing of the stand 120 other than the cover 121 may be made of metal etc., through which it is difficult for radio waves to pass. As a matter of course, the outer casing of the stand 120 may be partially or wholly non-conductive as long as the strength of the casing can be maintained by the shape or the member. However, as exemplified here, the outer casing of the stand 120 is preferably a member at least partially made of metal etc. to keep the strength of the casing when heavy components such as the operation unit 130 and other sensors are disposed on the stand 120. In this case, in particular, the first antenna 102 is preferably disposed on the front side of the stand 120 in consideration of the reception range for radio waves as illustrated in FIG. 1 etc.

As illustrated in FIG. 1, the platform 110 may include a non-conductive cover 112 that covers a portion in which the second antenna 103 is disposed and that forms a part of the outer casing of the platform 110. The second antenna 103 is disposed at a position on the outer side in the direction of the outer periphery and at which the second antenna 103 is not covered by a structural member of the platform 110 other than the cover 112. While the cover 112 may be made of a resin etc., for example, the cover 112 may be made of any non-conductive material. Providing the cover 112 can make the second antenna 103 visually unrecognizable from the outside, improving the appearance of the transport robot 100. The outer casing of the platform 110 other than the cover 112 may be made of metal etc., but may be partially or wholly non-conductive.

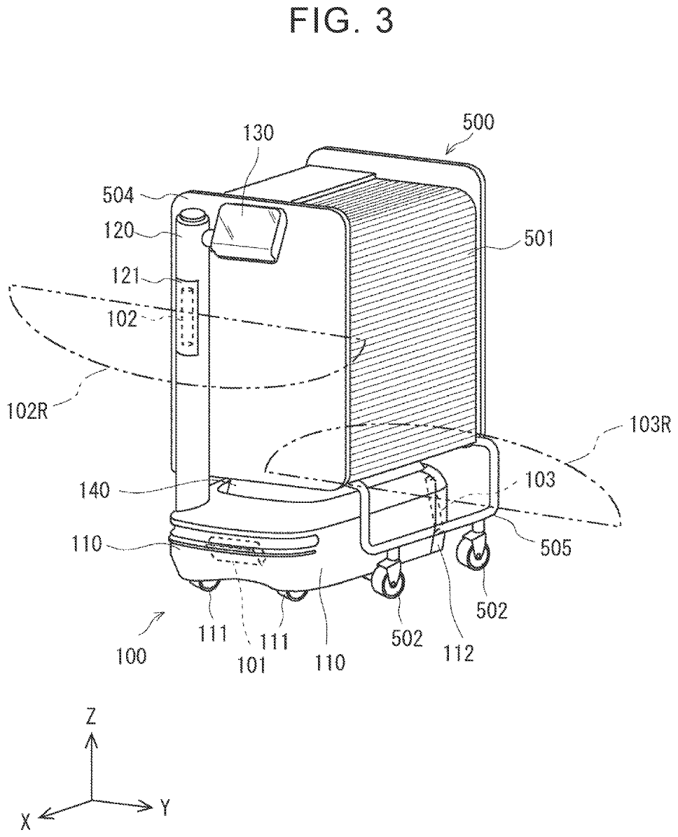

The platform 110 may include an elevation mechanism 140 for loading and unloading of a transport object. A part of the elevation mechanism 140 can be housed inside the platform 110, and the elevation mechanism 140 can be disposed with a placement surface for placement of the transport object exposed to the upper surface side of the platform 110. The elevation mechanism 140 can be an elevation stage provided to be elevatable, and can be elevated and lowered according to control by the control computer 101. The platform 110 is provided with a motor and a guide mechanism for elevation. The upper surface of the elevation mechanism 140 serves as a placement surface for placement of a wagon as the transport object. The wagon may be any predetermined wagon of a size, shape, and weight that is loadable and transportable on the elevation mechanism 140. While examples of the wagon include a wagon 500 illustrated in FIGS. 3 to 5 to be discussed later, this is not limiting. The elevation mechanism 140 includes a lift mechanism that lifts the wagon. A space above the elevation mechanism 140 serves as a mounting space for mounting of the transport object. The platform 110 may not include the elevation mechanism 140 in operation in which the user loads the wagon 500.

The stand 120 is attached to the platform 110. The stand 120 is a rod-shaped member that extends upward from the platform 110. While the stand 120 is formed in a circular column shape with its longitudinal direction corresponding to the Z direction here, the stand 120 may have any shape as a matter of course. The longitudinal direction of the stand 120 is parallel to the Z direction. The stand 120 is disposed outside the elevation mechanism 140. That is, the stand 120 is disposed so as not to interfere with elevating and lowering operation of the elevation mechanism 140. The stand 120 is disposed on one end side of the platform 110 in the Y direction (right-left direction). The stand 120 is attached in the vicinity of the front right corner portion of the platform 110. The stand 120 is provided at an end portion of the platform 110 on the +X side and the −Y side in the XY plane. The stand 120 with the first antenna 102 may also be attached in the vicinity of the front left corner portion of the platform 110. In this case, the second antenna 103 is disposed in the vicinity of the rear right corner portion of the platform 110.

The stand 120 supports the operation unit 130. The operation unit 130 is attached in the vicinity of the upper end of the stand 120. This allows the operation unit 130 to be installed at a height at which the operation unit 130 is easily operable by the user. That is, the stand 120 extends to a height at which the user standing can easily perform an operation. The operation unit 130 extends toward the +Y side from the stand 120. The operation unit 130 is disposed at the middle of the platform 110 in the right-left direction.

The operation unit 130 can include a touch panel monitor etc. that receives operations by the user. As a matter of course, the operation unit 130 can include a microphone etc. for audio input. The monitor of the operation unit 130 faces the opposite side from the platform 110. That is, a display surface (operation surface) of the operation unit 130 is a surface on the +X side. The operation unit 130 may be provided to be detachable from the stand 120. That is, a holder that holds a touch panel may be attached to the stand 120. The user can input a transport destination for the transport object, transport information about the transport object, etc. by operating the operation unit 130. Further, the operation unit 130 can display information such as the content of the transport object, the transport object expected to be transported, and the destination to the user during transport.

The upper surface portion of the stand 120 may be provided with a stick portion of a joystick device, for example, or provided with an emergency stop button, an indication lamp that indicates the operation state etc. of the transport robot 100, etc. This joystick device is a device that is operated to move the transport robot 100 in a direction intended by the user when in the user operation mode.

The user places a transport object in a wagon placed on the transport robot 100, and requests transport. The wagon itself can also be referred to as a transport object. Therefore, for convenience, a transport object placed in the wagon will hereinafter be referred to as an article in order for distinction. The transport robot 100 autonomously moves to a set destination to transport the wagon. That is, the transport robot 100 executes a task of transporting the wagon. In the following description, a location at which the wagon is mounted will be referred to as a transport origin or a loading location, and a location to which the wagon is delivered will be referred to as a transport destination or a destination.

For example, it is assumed that the transport robot 100 moves in a general hospital with a plurality of clinical departments. The transport robot 100 transports articles such as supplies, consumables, and medical instruments among the clinical departments. For example, the transport robot 100 delivers articles from a nurse station of a certain clinical department to a nurse station of another clinical department. Alternatively, the transport robot 100 delivers articles from a storage for supplies and medical instruments to a nurse station of a clinical department. The transport robot 100 also delivers medicine dispensed in a dispensing department to a clinical department or a patient expected to use the medicine.

Examples of the articles include drugs, consumables such as bandages, specimens, inspection instruments, medical instruments, hospital diets, and supplies such as stationery. Examples of the medical instruments include sphygmomanometers, blood transfusion pumps, syringe pumps, foot pumps, nurse call buttons, bed leaving sensors, low-pressure continuous inhalers, electrocardiogram monitors, drug injection controllers, enteral nutrition pumps, artificial respirators, cuff pressure gauges, touch sensors, aspirators, nebulizers, pulse oximeters, artificial resuscitators, aseptic devices, and echo machines. Meals such as hospital diets and inspection diets may also be transported. The transport robot 100 may further transport instruments that have been used, tableware that has been used, etc. When the transport destination is on a different floor, the transport robot 100 may move using an elevator etc.

In the transport robot 100 discussed above, a stand that extends upward from the platform 110 on which a transport object is to be mounted is disposed, and the first antenna 102 and the second antenna 103 are disposed at positions facing each other on a diagonal line in the direction parallel to the transport robot 100. That is, the first antenna 102 and the second antenna 103 are disposed at diagonal positions in the direction parallel to the transport robot 100.

In the transport robot 100 with such an antenna arrangement, degradation in the reception state, in particular degradation in the reception state due to the installation of the stand 120, can be suppressed for radio waves from all directions around the transport robot 100, that is, radio waves from all directions around the platform 110. The transport robot 100 includes many components made of metal, and therefore it is difficult for radio waves to pass through the transport robot 100. With such an antenna arrangement, however, degradation in the reception state can be suppressed for radio waves from all directions around the platform 110.

Next, transport of the wagon as the transport object by the transport robot 100 will be described with reference to FIGS. 3 to 5. FIGS. 3, 4, and 5 are a perspective view, a front view, and a side view, respectively, illustrating how the transport robot 100 in FIG. 1 transports the wagon. While FIG. 3 illustrates the region 102R for the first antenna 102 and the region 103R for the second antenna 103, such regions indicate ranges in which the antennas have high reception sensitivity only around the center of the antennas in the Z-axis direction for convenience.

As illustrated in FIGS. 3 to 5, the transport robot 100 can hold the wagon 500 using the elevation mechanism 140. The elevation mechanism 140 is a mechanism that loads and unloads a predetermined wagon as a transport object on and off the upper surface side of at least a part of the platform 110. Here, the predetermined wagon includes a housing portion that houses articles, and a support portion that supports the housing portion with a space secured under the housing portion to allow insertion of at least a part of the platform 110.

While examples of the predetermined wagon include the wagon 500 illustrated in FIGS. 3 to 5 here, this is not limiting. The wagon 500 houses articles inside. The housing portion can be configured to include side plates 504 on both sides of the wagon 500 and an openable cover 501. The user can load and unload articles by opening the cover 501.

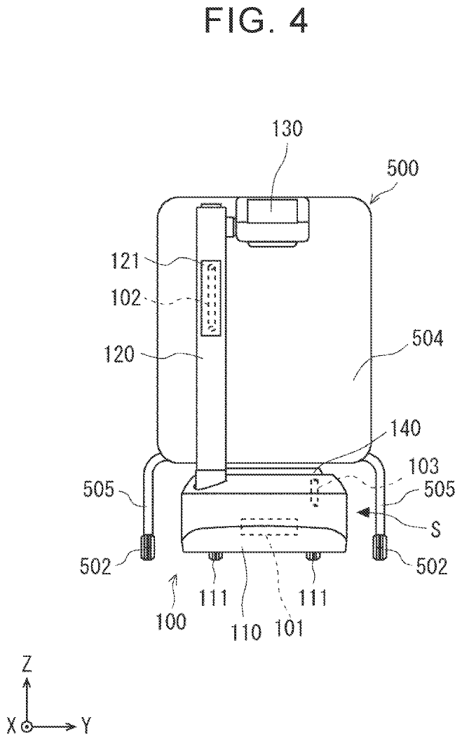

The support portion can be configured to include support frames 505 that support the housing portion, and wheels 502 attached under the support frames 505. The wheels 502 can include covers (not illustrated). The space is a space S secured under the wagon 500 as illustrated in FIG. 4. The space S allows insertion of the platform 110. That is, the platform 110 can be inserted into the space S directly under the wagon 500. When the wagon 500 is mounted onto the platform 110, the transport robot 100 moves in the −X direction to enter the space directly under the wagon 500. The platform 110 enters the space directly under the wagon 500 from the side on which the stand 120 is not provided in the front-rear direction. In this manner, the wagon 500 can be mounted without the stand 120 interfering with the wagon 500. In other words, the stand 120 is attached in the vicinity of the corner portion of the platform 110 so as not to interfere with the wagon 500.

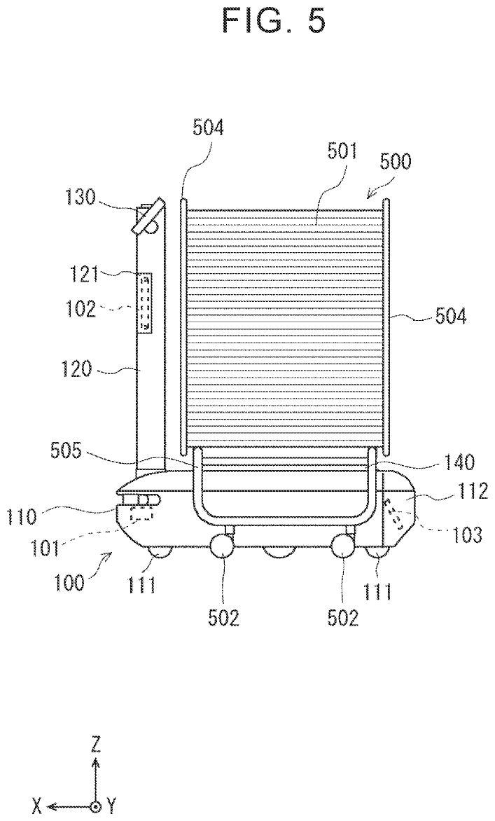

As exemplified in FIG. 5, the first antenna 102 and the second antenna 103 may be disposed at positions not overlapping the wagon 500 with the wagon 500 loaded on the platform 110 in the direction parallel to the platform 110. That is, the transport robot 100 structured to include antennas mounted for wireless communication travels with the wagon 500 which tends to reduce the intensity of radio waves being mounted on the transport robot 100, and therefore the antennas are preferably disposed such that the reception ranges of the antennas do not interfere with not only the robot body including the platform 110 etc. but also the wagon 500. By employing such a configuration, the transport robot 100 can not only transport articles in the wagon 500, but also suppress degradation in the reception state of radio waves even during transport of the wagon 500.

As can be seen from the regions 102R and 103R in FIG. 3, the first antenna 102 and the second antenna 103 are disposed so as to have isotropic wide reception ranges that facilitate picking up communication radio waves, irrespective of the travel direction of the exemplified transport robot 100. That is, the first antenna 102 and the second antenna 103 are disposed such that the reception sensitivity is reduced as little as possible even when the transport robot 100 travels with the wagon 500 placed on the transport robot 100. Therefore, the transport robot 100 can easily receive radio waves through the first antenna 102 and the second antenna 103 even in the presence of the wagon 500 and the transport object placed in the wagon 500 that serve as shielding objects. This makes it possible to reduce scenes in which the transport robot 100 cannot establish communication with the outside and the transport robot 100 is isolated.

As illustrated in FIGS. 1 and 2, the mounting surface of the elevation mechanism 140 can include recessed portions 141. On the other hand, projecting portions (not illustrated) can be provided on the lower side of the housing portion of the wagon 500. The wagon 500 can be fixed to the transport robot 100 by fitting the projecting portions into the recessed portions 141.

While the wagon 500 is indicated as a cart that includes the wheels 502, the shape and the configuration of the wagon 500 are not specifically limited. The predetermined wagon exemplified by the wagon 500 may have any shape, size, and weight that enable the wagon to be transported by the transport robot 100.

Operation to load the wagon 500 will be described. When the platform 110 enters the space S directly under the wagon 500, the elevation mechanism 140 is elevated. This allows the elevation stage as the upper surface of the elevation mechanism 140 to contact the wagon 500. The elevation mechanism 140 can lift the wagon 500. That is, when the elevation mechanism 140 is elevated, the wagon 500 is mounted on the platform 110 with the wheels 502 brought off the ground.

When the wagon 500 is to be unloaded from the platform 110, the elevation mechanism 140 is lowered. The wheels 502 are brought into contact with the floor surface, and the upper surface of the elevation mechanism 140 is brought off the wagon 500. The wagon 500 is placed on the floor surface. The wagon 500 can be unmounted from the platform 110. The platform 110 is provided with four wheels 111. The four wheels 111 include right and left front wheels and right and left rear wheels. The transport robot 100 moves along a desired route by independently controlling the rotational direction and the rotational speed of the wheels 111. Some of the four wheels 111 may be drive wheels, and the rest may be driven wheels. As illustrated in FIG. 1 etc., additional driven wheels may be provided between the front and rear wheels 111 etc.

While it is assumed that the transport robot 100 transports a wagon such as the wagon 500 as a transport object in the example described above, the transport object may be individual articles (loads). In that case, the elevation mechanism 140 may not be provided, but a housing box, a shelf portion, etc. may be attached to the transport robot 100 so that the articles do not fall during movement. When the transport robot 100 transports a plurality of articles and it is necessary to transport the articles to a plurality of transport destinations, the user can unload the articles at the transport destinations, irrespective of whether the wagon 500 is used for the transport. The transport robot 100 can transport a wagon or individual articles by moving autonomously to a set destination or moving according to user operations.

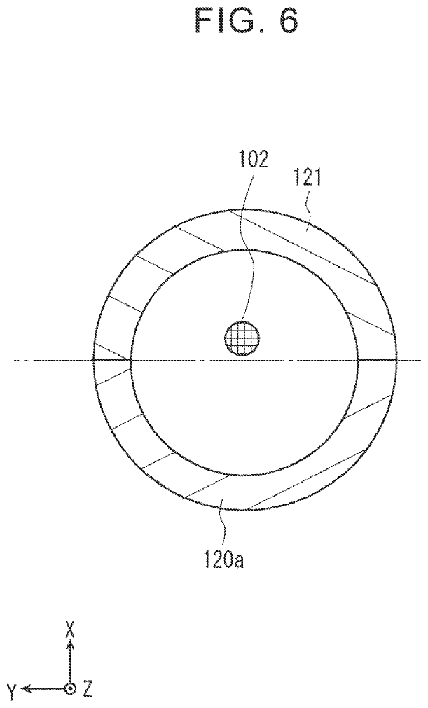

Next, an example of the arrangement of the first antenna 102 in the stand 120 of the transport robot 100 will be described with reference to FIG. 6. FIG. 6 is a horizontal cross-sectional view illustrating an example of the stand 120 of the transport robot 100.

As illustrated in FIG. 6, the outer casing of the stand 120, that is, a stand casing 120a that serves as a casing of the stand 120, is formed as a member made of metal etc., through which it is difficult for radio waves to pass, and the cover 121 made of a resin etc., through which it is easy for radio waves to pass, is provided at a position at which the first antenna 102 is disposed.

Here, heavy components such as the operation unit 130 and sensors are placed at the upper portion of the stand 120 as discussed above, and therefore the stand 120 requires a member with certain strength, and materials such as metal and a material containing metal as a part thereof can be used for the stand 120. In the transport robot 100, however, the first antenna 102 is disposed at a position on the front side with respect to the center position of the stand 120 in the front-rear direction indicated by the long dashed short dashed line in FIG. 6, and the cover 121 made of a resin etc. is provided as the outer casing at that position. This facilitates reception of radio waves compared to when the first antenna 102 is not positioned in this manner. The first antenna 102 may be positioned as illustrated in FIG. 6, or may be positioned further on the front side as illustrated in FIG. 2.

As illustrated in FIG. 6, the proportion of the stand casing 120a to the cover 121 made of a resin etc. at a height at which the cover 121 is provided may be determined as 1:1. As a matter of course, the proportion of the cover 121 may be lower than the proportion of the stand casing 120a as illustrated in FIGS. 1 and 3, or may conversely be higher than that. It is only necessary that the range of the cover 121 should be determined such that the reception sensitivity is reduced as little as possible.

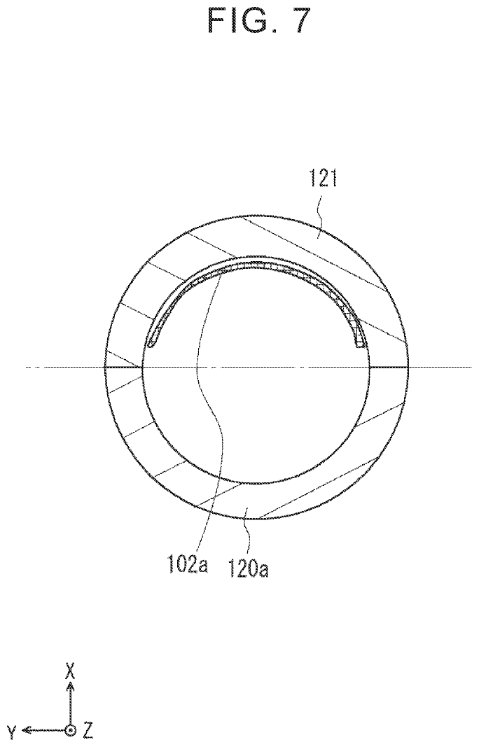

Next, a film antenna 102a as another example of the configuration of the first antenna 102 in the stand 120 of the transport robot 100 will be described with reference to FIG. 7. FIG. 7 is a horizontal cross-sectional view illustrating another example of the stand 120 of the transport robot 100.

As illustrated in FIG. 7, the stand casing 120a is formed as a member made of metal etc., through which it is difficult for radio waves to pass, and the cover 121 made of a resin etc., through which it is easy for radio waves to pass, is provided at a position at which the first antenna is disposed. As illustrated in FIG. 7, a film antenna 102a can be pasted on the inner side of the cover 121 as the first antenna.

While the first antenna 102 or the film antenna 102a and the second antenna 103 are disposed on the front right side and the rear left side, respectively, in the transport robot 100 described with reference to FIGS. 1 to 7, the arrangement of these is not limited to those exemplified in the drawings. While the first antenna 102 is used as the first antenna in the following description, the same description is similarly applicable to the film antenna 102a.

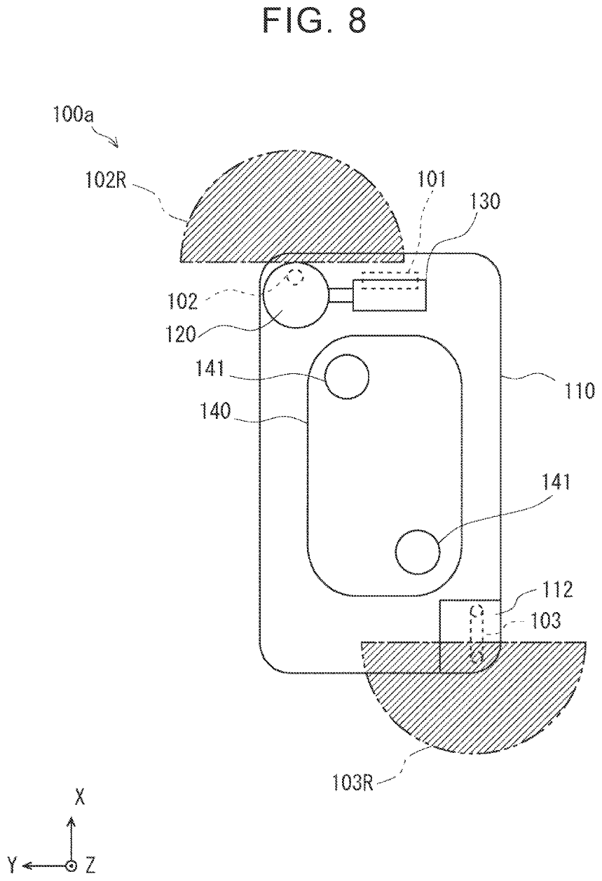

For example, the first antenna 102 and the second antenna 103 may be disposed on the front left side and the rear right side, respectively, as in an example of the antenna arrangement in FIG. 8 illustrating the ranges 102R and 103R in which the antennas receive radio waves with high reception sensitivity. Here, FIG. 8 is a top view illustrating a different example of the configuration of the transport robot according to the present embodiment.

A transport robot 100a illustrated in FIG. 8 is constituted by inverting the position of the stand 120 and the arrangement of the first antenna 102 and the second antenna 103 in the transport robot 100 between the right and the left with respect to the travel direction. That is, in the transport robot 100a, the first antenna 102 is disposed on the left side of the transport robot 100a so as to be able to receive radio waves from the front side (+X side), and the second antenna 103 is disposed on the right side of the transport robot 100a so as to be able to receive radio waves from the rear side (−X side).

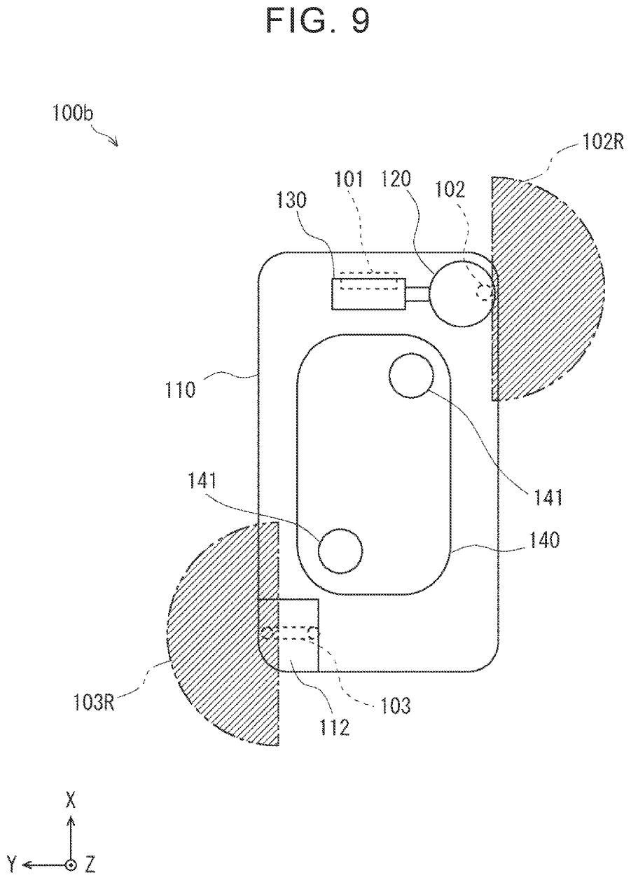

The first antenna 102 and the second antenna 103 may be disposed such that the ranges 102R and the 103R are positioned on the right lateral side and the left lateral side, respectively, as in an example of the antenna arrangement in FIG. 9 illustrating the ranges 102R and 103R in which the antennas receive radio waves with high reception sensitivity. Here, FIG. 9 is a top view illustrating a different example of the configuration of the transport robot according to the present embodiment. Also in FIG. 9, as in FIG. 2, ranges in which the antennas receive radio waves for wireless communication with high reception sensitivity are indicated as hatched regions.

A transport robot 100b illustrated in FIG. 9 is constituted by disposing the first antenna 102 and the second antenna 103 in the transport robot 100 such that the ranges 102R and 103R are rotated by 90 degrees with the stand 120 kept at the same position. That is, in the transport robot 100b, the first antenna 102 is disposed so as to be able to receive radio waves from the right side (−Y side) of the transport robot 100b, and the second antenna 103 is disposed so as to be able to receive radio waves from the left side (+Y side) of the transport robot 100b.

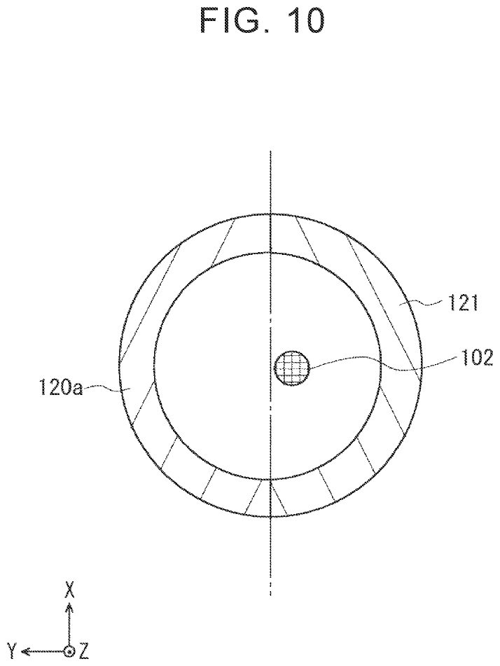

Next, an example of the arrangement of the first antenna 102 in the stand 120 of the transport robot 100b will be described with reference to FIG. 10. FIG. 10 is a horizontal cross-sectional view illustrating an example of the stand 120 of the transport robot 100b.

As illustrated in FIG. 10, the stand casing 120a is formed as a member made of metal etc., through which it is difficult for radio waves to pass, and the cover 121 made of a resin etc., through which it is easy for radio waves to pass, is provided at a position at which the first antenna 102 is disposed.

In the transport robot 100b, the first antenna 102 is disposed at a position on the right side with respect to the center position of the stand 120 in the right-left direction indicated by the long dashed short dashed line in FIG. 10, and the cover 121 made of a resin etc. is provided as the outer casing at that position. This facilitates reception of radio waves compared to when the first antenna 102 is not positioned in this manner. The first antenna 102 may be positioned as illustrated in FIG. 10, or may be positioned further on the right side as illustrated in FIG. 9.

As illustrated in FIG. 10, the proportion of the stand casing 120a to the cover 121 made of a resin etc. at a height at which the cover 121 is provided may be determined as 1:1. As described in relation to FIG. 6, however, it is only necessary that the range of the cover 121 should be determined such that the reception sensitivity is reduced as little as possible.

While the first antenna 102 or the film antenna 102a is disposed in the stand 120 and the second antenna 103 is disposed at a diagonal position from the position at which the first antenna 102 or the film antenna 102a is disposed in the examples in FIGS. 1 to 10, such an arrangement of the antennas is not limiting.

For example, the first antenna 102 or the film antenna 102a may be disposed inside the platform 110 and on the other end side of the platform 110 in the right-left direction. The other end indicates the side on which the stand 120 is not disposed. In this arrangement, the second antenna 103 is disposed at a diagonal position from the position at which the first antenna 102 or the film antenna 102a is disposed. In this case, when described with reference to FIGS. 2, 8, and 9, the first antenna 102 or the film antenna 102a is disposed at an end portion of the platform 110 on the +X side and the +Y side, and the second antenna 103 is disposed at an end portion of the platform 110 on the −X side and the −Y side. In this manner, the first antenna 102 or the film antenna 102a and the stand 120 may also be disposed at positions on the same surface side and away from each other in the direction parallel to the platform 110.

When the transport robot 100, 100a, 100b employs such a configuration, it is not necessary to provide the stand 120 with the first antenna 102 or the film antenna 102a, achieving a reduction in weight and thickness of the stand 120.

The first antenna 102 or the film antenna 102a and the second antenna 103 may be disposed at positions away from the stand 120 other than those discussed above, and may be disposed at positions inside the platform 110 and facing each other on a diagonal line in the direction parallel to the platform 110, for example. For example, the first antenna 102 or the film antenna 102a and the second antenna 103 may be disposed at positions on the right and left sides of the platform 110 and around the center in the front-rear direction, at positions on the front and rear sides of the platform 110 and around the center in the right-left direction, etc.

While the film antenna 102a is applicable in place of the first antenna 102 in the above examples, a film antenna pasted to the inside of the casing of the platform 110 is also applicable as the second antenna 103.

While the above various configuration examples have been described on the assumption that the stand 120 is disposed on one end side of the platform 110 in the right-left direction, such an arrangement of the stand 120 is not limiting. While the above various configuration examples have been described on the assumption that the second antenna 103 is disposed at a position inside the platform 110 and facing the position at which the first antenna 102 or the film antenna 102a is disposed on a diagonal line in the direction parallel to the platform 110, such an arrangement of the antennas is not limiting.

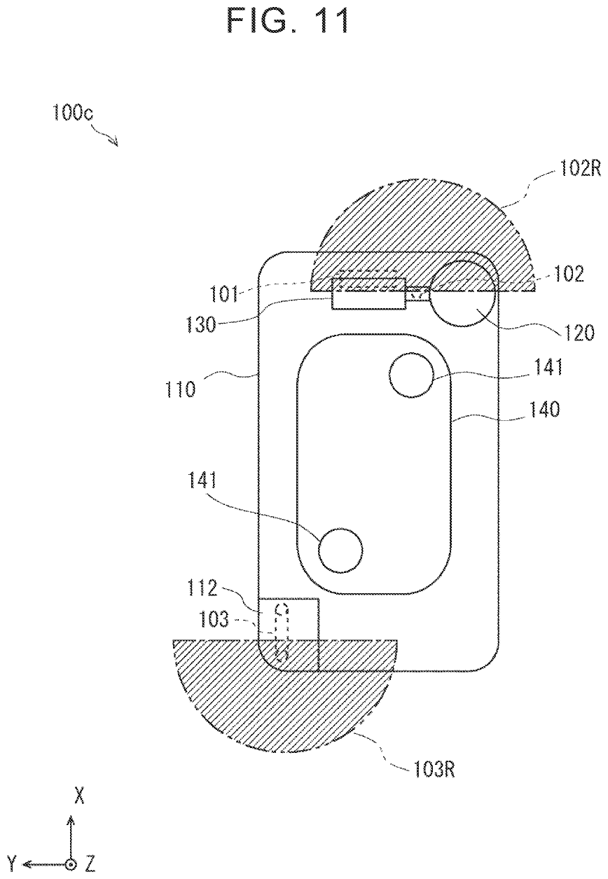

Still other configuration examples of the arrangement of the stand 120 and the arrangement of the two antennas will be described with reference to FIGS. 11 to 16. FIGS. 11 to 16 are each a top view illustrating another example of the configuration of the transport robot according to the present embodiment. FIGS. 11 to 16 illustrate mutually different configuration examples. While examples with a film antenna are not mentioned in the following examples, a film antenna is applicable as one or both of the first antenna 102 and the second antenna 103.

In a transport robot 100c illustrated in FIG. 11, the first antenna 102 is disposed outside the stand 120 to face a direction in which the stand 120 extends, rather than being disposed inside the stand 120 along a direction in which the stand 120 extends as in the transport robot 100 illustrated in FIG. 2. In examples in which the first antenna 102 is disposed outside the stand 120, the first antenna 102 may be disposed between the stand 120 and the operation unit 130 as illustrated in FIG. 11, or may be disposed inside the operation unit 130. Such an arrangement of the first antenna 102 is also applicable to the following various examples as a matter of course.

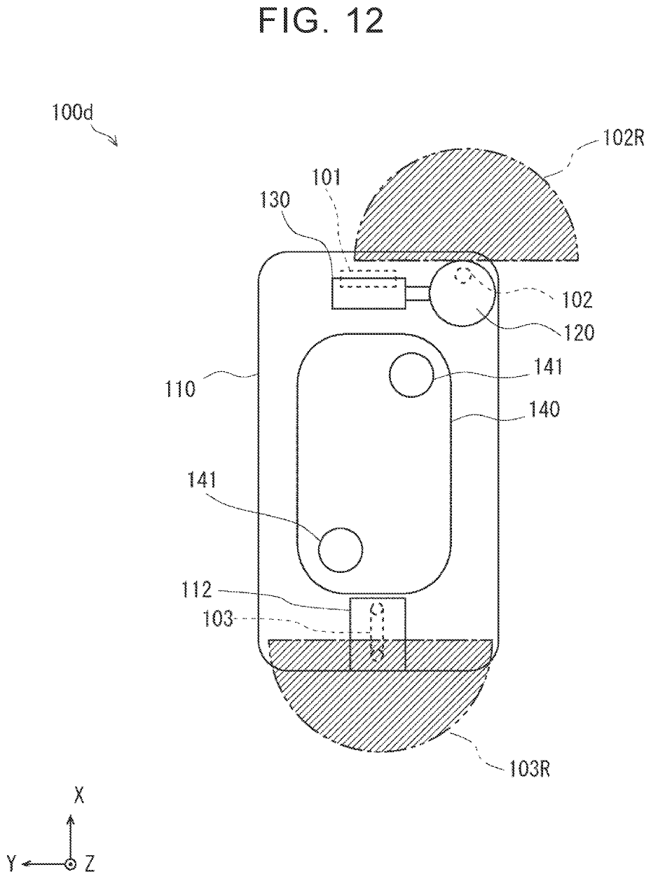

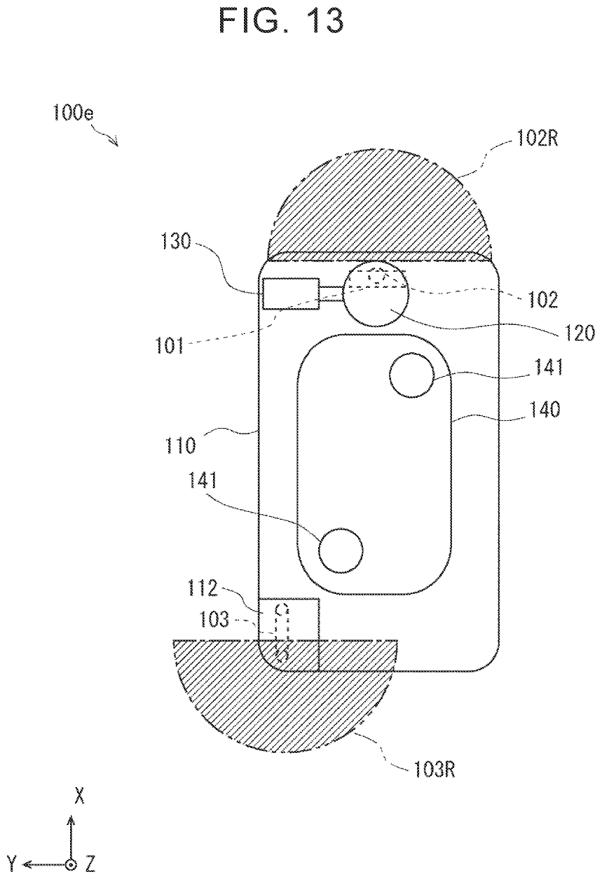

A transport robot 100d illustrated in FIG. 12 is the same as the transport robot 100 illustrated in FIG. 2 in that the stand 120 is disposed at the front portion of the platform 110 and on one end side of the platform 110 in the right-left direction, but is different from the transport robot 100 in the arrangement of the second antenna 103. Specifically, in the transport robot 100d, the second antenna 103 is disposed at a position inside the platform 110 and at the center portion of the platform 110 in the right-left direction, rather than at a position facing the position at which the first antenna 102 is disposed on a diagonal line. The second antenna 103 is not limited to being disposed at the center portion, and the first antenna 102 and the second antenna 103 may simply be disposed on the opposite end surface sides of the platform 110 with the center portion of the platform 110 interposed between each other. When the second antenna 103 is disposed at a position inside the platform 110, it is not necessary to provide another stand, for example, in order to provide the second antenna 103. The transport robot 100 and the transport robots 100a to 100d make it easy to visually recognize the mounting state of the transport object on the platform 110 from the front side compared to configurations in which the stand 120 is disposed at the center portion of the platform 110 in the right-left direction to be discussed later with reference to FIGS. 13 to 15.

Alternatively, a similar effect is achieved by a configuration obtained by inverting the stand 120 and the first antenna 102 and the second antenna 103 in the front-rear direction in the transport robot 100d. That is, a similar effect is achieved when the stand 120 is disposed at the rear portion of the platform 110 and on one end side of the platform 110 in the right-left direction and the second antenna 103 is located at the front portion of the platform 110.

In a transport robot 100e illustrated in FIG. 13, the stand 120 is disposed at the front portion of the platform 110 and at the center portion of the platform 110 in the right-left direction, unlike the transport robot 100c illustrated in FIG. 11. The transport robot 100e is well balanced in terms of weight of the transport robot 100e compared to a configuration in which the stand 120 is disposed on one end side of the platform 110 in the right-left direction. In the transport robot 100e, as a matter of course, the second antenna 103 may be disposed at a position inside the platform 110 and at the center portion of the platform 110 in the right-left direction, as in the transport robot 100d in FIG. 12.

Alternatively, a similar effect is achieved by a configuration obtained by inverting the stand 120 and the first antenna 102 and the second antenna 103 in the front-rear direction in the transport robot 100e. That is, a similar effect is achieved when the stand 120 is disposed at the rear portion of the platform 110 and at the center portion of the platform 110 in the right-left direction and the second antenna 103 is located at the front portion of the platform 110.

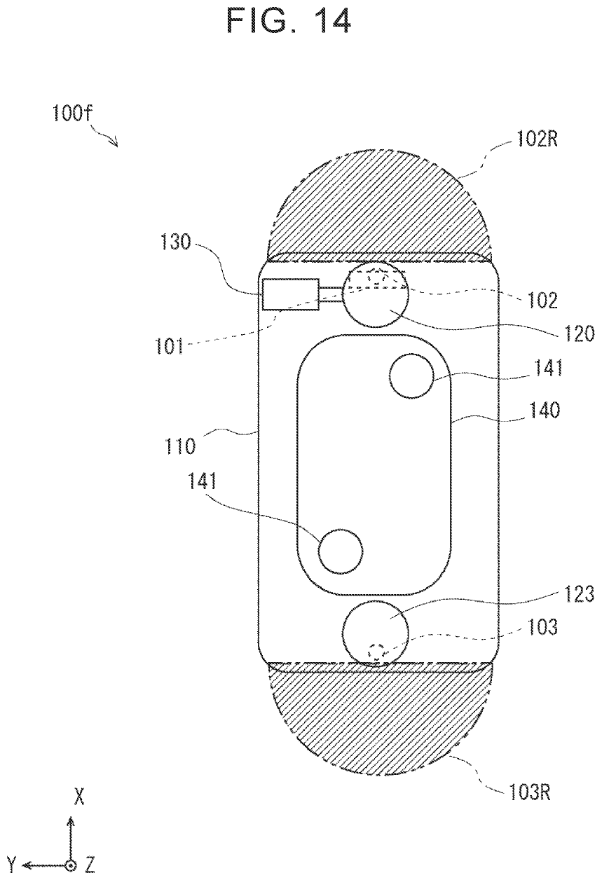

In the transport robot, another stand that is different from the stand 120 may be disposed so that the second antenna 103 is disposed in the different stand. For example, a transport robot 100f illustrated in FIG. 14 includes a different stand 123 that extends upward from the platform 110, besides the stand 120, inside or outside which the first antenna 102 is disposed. In the transport robot 100f, the stand 120 is disposed at the front portion of the platform 110 and at the center portion in the right-left direction. The stand 123 is disposed on the opposite end surface side from the stand 120 with the center portion of the platform 110 interposed between each other in the direction parallel to the platform 110. In the transport robot 100f, the second antenna 103 is disposed inside the stand 123 along a direction in which the stand 123 extends. When the transport robot 100f employs such a configuration, the second antenna 103 can not only be easily housed in the stand 123, but also keep a good reception state even when the external device is located far from the transport robot 100f.

As with the examples of the stand 120, the stand 123 may include a non-conductive cover that covers a portion in which the second antenna 103 is disposed and that forms a part of the outer housing of the stand 123. Providing such a cover can make the second antenna 103 visually unrecognizable from the outside, improving the appearance of the transport robot 100f.

Here, the second antenna 103 can be disposed inside the stand 123 along a direction in which the stand 123 extends. Alternatively, the second antenna 103 may be disposed outside the stand 123, such as between the stand 123 and the operation unit attached to the stand 123 or inside the operation unit, to face a direction in which the stand 123 extends, for example.

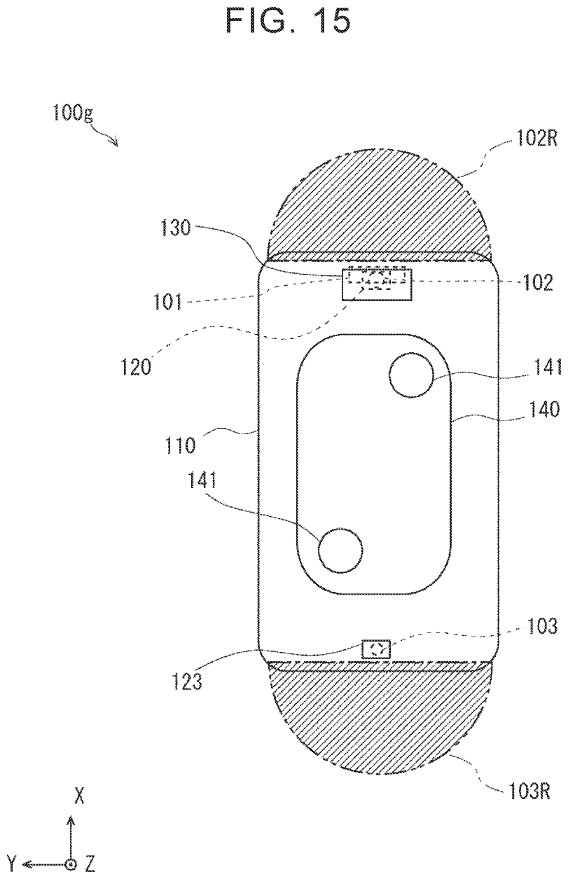

As a matter of course, the cross-sectional shape of the stand 120 and the stand 123 is not limited to a circular shape or an elliptical shape, and may be a rectangular shape etc. A modification of the transport robot 100f will be described. It is seen in a transport robot 100g illustrated in FIG. 15 that the stands 120 and 123 have a rectangular cross-sectional shape. While the operation unit 130 is disposed at the upper end of the stand 120 in the transport robot 100g, the operation unit 130 may be disposed on the Y-direction side as in the other examples.

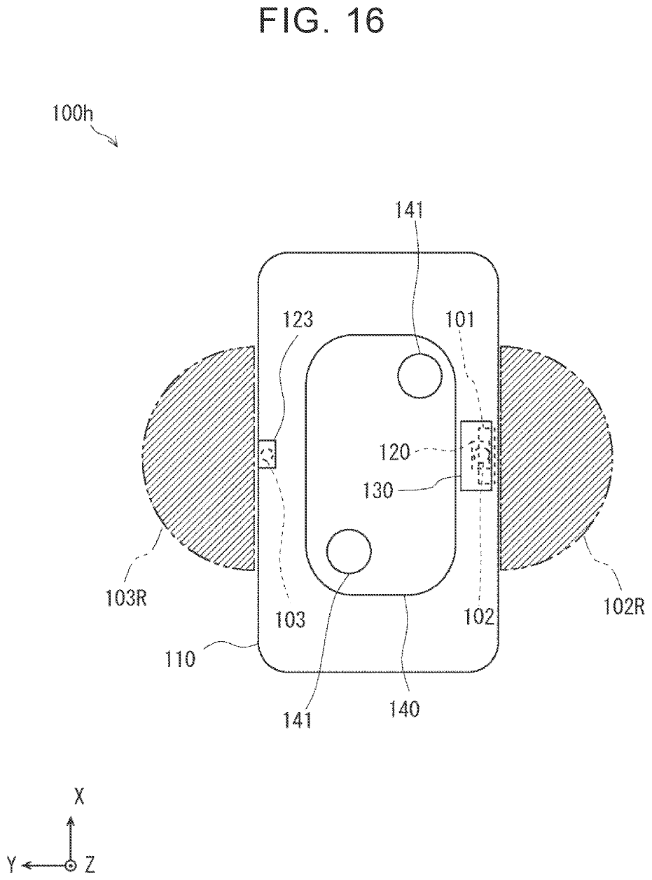

In a transport robot, the stand 120, or the stand 120 and the stand 123, may be disposed at lateral portions of the platform 110. For example, in a transport robot 100h illustrated in FIG. 16, the stand 120 and the stand 123 are disposed at lateral portions of the platform 110 and at the center portion of the platform 110 in the front-rear direction. The transport robot 100h makes it easy to visually recognize the mounting state of the transport object on the platform from the front side or the rear side compared to a configuration in which the stand 120 and the stand 123 are disposed at the front portion or the rear portion of the platform. Also when the stand 120 and the stand 123 are disposed at lateral portions of the platform 110, the stand 120 and the stand 123 may be disposed on one end side of the platform 110 in the front-rear direction, rather than at the center portion of the platform 110 in the front-rear direction. In either case, the transport robot is well balanced in terms of weight of the transport robot compared to a configuration in which the stand is disposed on one end side of the platform in the front-rear direction.

In the transport robot 100b illustrated in FIG. 9, the stand 120 may be slightly displaced toward the −X side, for example. In such a transport robot, it is considered that the stand 120 is disposed at a lateral portion of the platform 110 and on one end side of the platform 110 in the front-rear direction. Also in this configuration, the stand 123 can be provided, and also in that case the stand 120 can be similarly disposed on one end side of the platform 110 in the front-rear direction. Such a transport robot makes it easy to visually recognize the mounting state of the transport object on the platform 110 from the front side or the rear side compared to a configuration in which the stand 120 and the stand 123 are disposed at the front portion or the rear portion of the platform 110. In addition, such a transport robot makes it easy to visually recognize the transport state of the transport object on the platform 110 from a lateral side compared to a configuration in which the stand 120 and the stand 123 are disposed at the center portion of the platform 110 in the front-rear direction.

The program discussed above includes a group of instructions (or software codes) for causing a computer to perform one or more of the functions described in relation to the embodiment when loaded into the computer. The program may be stored in a non-transitory computer-readable medium or a tangible storage medium. Examples of the computer-readable medium or the tangible storage medium include, but are not limited to, a random-access memory (RAM), a read-only memory (ROM), a flash memory, a solid-state drive (SSD), and other memory technologies, a compact disc read-only memory (CD-ROM), a digital versatile disc (DVD), a Blu-ray (registered trademark) disc, and other optical disc storages, and a magnetic cassette, a magnetic tape, a magnetic disk storage, and other magnetic storage devices. The program may be transmitted on a transitory computer-readable medium or a communication medium. Examples of the transitory computer-readable medium or the communication medium include, but are not limited to, propagating signals in electrical, optical, acoustic, or other forms.

The present disclosure is not limited to the above embodiment, and can be modified as appropriate without departing from the spirit and scope of the present disclosure.

What is claimed is:

1. A transport robot comprising:
a platform configured to allow a transport object to be mounted on the platform;
a stand that extends upward from the platform; and
a wireless communication unit configured to perform wireless communication with an external device using radio waves in a predetermined frequency band, wherein:
the wireless communication unit includes a first wireless communication antenna and a second wireless communication antenna disposed so as to receive radio waves at least from an outer side in a direction parallel to the platform; and
the first wireless communication antenna and the second wireless communication antenna are disposed on opposite end surface sides of the platform with a center portion of the platform interposed between each other in the direction parallel to the platform.

2. The transport robot according to claim 1, wherein the first wireless communication antenna is disposed inside the stand along a direction in which the stand extends.

3. The transport robot according to claim 2, wherein the stand includes a non-conductive cover that covers a portion in which the first wireless communication antenna is disposed and forms a part of an outer casing of the stand.

4. The transport robot according to claim 1, wherein the stand is disposed at a front portion or a rear portion of the platform and on one end side of the platform in a right-left direction.

5. The transport robot according to claim 1, wherein the stand is disposed at a front portion or a rear portion of the platform and at a center portion of the platform in a right-left direction.

6. The transport robot according to claim 1, wherein the stand is disposed at a lateral portion of the platform and on one end side of the platform in a front-rear direction.

7. The transport robot according to claim 1, wherein the stand is disposed at a lateral portion of the platform and at a center portion of the platform in a front-rear direction.

8. The transport robot according to claim 1, wherein the second wireless communication antenna is disposed at a position inside the platform.

9. The transport robot according to claim 1, wherein the second wireless communication antenna is disposed at a position inside the platform and facing a position at which the first wireless communication antenna is disposed on a diagonal line in the direction parallel to the platform.

10. The transport robot according to claim 1, wherein:
the second wireless communication antenna is disposed at a position inside the platform; and
the platform includes a non-conductive cover that covers a portion at which the second wireless communication antenna is disposed and forms a part of an outer casing of the platform.

11. The transport robot according to claim 1, further comprising a different stand disposed on an opposite end surface side from the stand with a center portion of the platform interposed between the two stands in the direction parallel to the platform, wherein the second wireless communication antenna is disposed inside the different stand along a direction in which the different stand extends.

12. The transport robot according to claim 11, wherein the different stand includes a non-conductive cover that covers a portion at which the second wireless communication antenna is disposed and forms a part of an outer casing of the different stand.

13. The transport robot according to claim 1, wherein the first wireless communication antenna and the stand are disposed at positions on the same surface side and away from each other in the direction parallel to the platform.

14. The transport robot according to claim 1, further comprising an elevation mechanism provided on an upper surface side of at least a part of the platform and configured to load and unload a predetermined wagon as the transported object, wherein:
the predetermined wagon includes a housing portion configured to house an article, and a support portion configured to support the housing portion with a space secured under the housing portion to allow insertion of at least a part of the platform; and
the first wireless communication antenna and the second wireless communication antenna are disposed at positions not overlapping the predetermined wagon in the direction parallel to the platform with the predetermined wagon loaded on the platform.
